(19) United States
(12) Patent Application Publication
(10) Pub. No.: US 2008/0235040 A1
(43) Pub. Date: Sep. 25, 2008

(54) GPS-BASED ACTIVITY MANAGEMENT

(76) Inventors: Mark Ratliff, Grosse Pointe Farms, MI (US); Jesse Duggan, Toronto (CA)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/690,520

(22) Filed: Mar. 23, 2007

(51) Int. Cl. G06Q 10/00

(52) U.S. Cl. 705/1

(57) ABSTRACT

A remote device may received location information identifying a location of the remote device. An event is written to a data store upon receiving the information concerning the location of the remote device, the event including the location of the remote device and an identifier for the remote device or a user thereof. The data store is selectively queried for an association between the event and the customer location. A remote application is queried via a network, upon receiving the association, for information regarding a customer associated with the customer location.

### BACKGROUND INFORMATION

Mobile professionals who spend a substantial amount of time away from their employer's office, such as service personnel, outside sales representatives, and the like, may travel to one or more customer locations during the course of the day, and may travel to many customer locations during the course of a week, a month, etc. Revenues and profits of organizations employing such mobile professionals may depend upon mobile professionals making timely and efficient visits to customer locations. For example, mobile professionals may be required to make visits to a specified number of customer locations within a specified period of time, e.g., a day, a week, etc. Further, mobile professionals may be required to spend a minimum amount of time at each customer location visited. However, an employer of such mobile professionals quite often has no way of verifying the customer locations visited by a person in the field, or the dates and times when such customer locations were visited. Moreover, when making such visits, mobile professionals may lack relevant and important information concerning a customer that they are visiting. Further, having made such visits, mobile professionals may delay or even neglect inputting information concerning customer visits into a customer relationship management (CRM) system or the like, e.g., salesforce.com, Microsoft® CRM, etc.

### BRIEF DESCRIPTION OF THE DRAWING FIGURES

FIG. 1 illustrates an exemplary location and customer reporting system.

FIG. 2 illustrates exemplary elements of an activity data store.

FIG. 3 illustrates an exemplary graphical user interface.

FIG. 4 illustrates an exemplary process for providing a mobile application to a mobile device.

FIG. 5 illustrates an exemplary process for populating a set of entity locations in a data store.

FIG. 6 illustrates an exemplary process for use of a mobile device.

FIG. 7 illustrates an exemplary process for a management server to communicate with a mobile device.

FIG. 8 illustrates an exemplary process for providing reports and/or alerts to a mobile application and/or a web client.

FIG. 9 illustrates an exemplary process for reporting information from a mobile device to a remote entity database.

### DETAILED DESCRIPTION OF THE PREFERRED EMBODIMENTS OVERVIEW OF EXEMPLARY SYSTEM

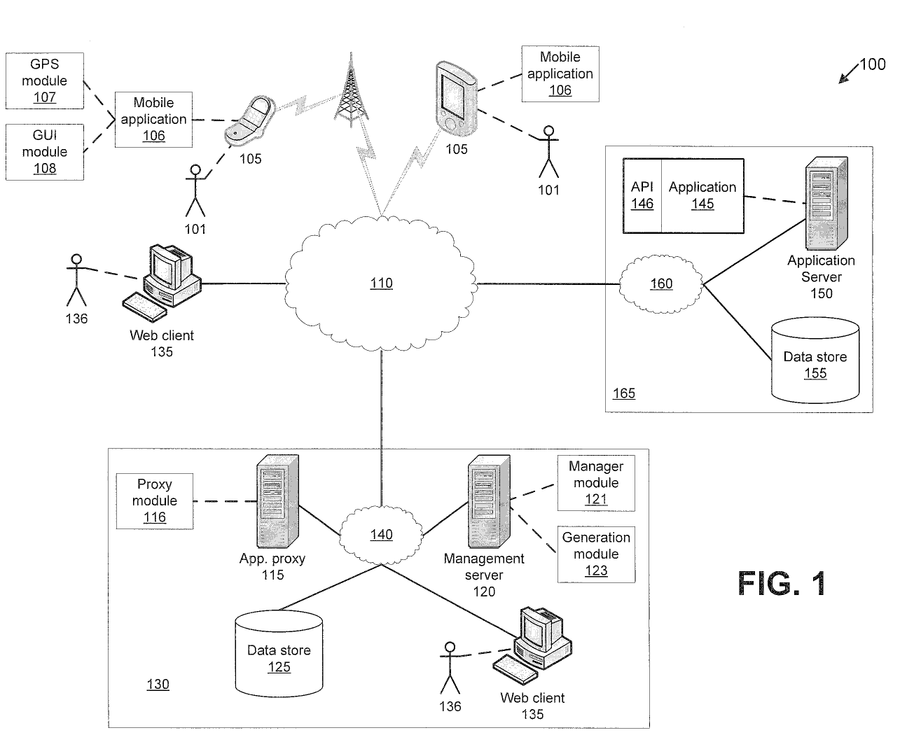

FIG. 1 illustrates an exemplary location and customer reporting system 100. A mobile professional such as a field user 101 may carry a mobile computing device 105 to one or more geographic locations. The mobile device 105 includes a global positioning system (GPS) (not shown) as is known for determining a geographic location of the mobile device 105. The mobile device 105 further includes a mobile application 106 that selectively provides the geographic location of the mobile device 105 to a management server 120 via a network 110. Mobile application 106 may include a GPS module 107 and a graphical user interface (GUI) module 108.

Management server 120 may be located within a data center 130 and includes a manager module 121 and a generation module 123. Management server 120 further generally includes a web server application (not shown in FIG. 1) such as is known for providing web pages and the like, receiving requests and inputs from users through such web pages, etc. Data center 130 may further include an application proxy server 115. Application proxy server 115 may include a proxy module 116.

Manager module 121 is generally configured to communicate with mobile device 105, and in particular with mobile application 106. Manager module 121 is further generally configured to communicate with an activity data store 125, which is also included in data center 130. Generation module 123 is generally configured to generate compiled software code including mobile application 106, and provide such software for download to mobile device 105. Further, the modules 116, 121, and 123 may communicate with one another as will be apparent in the descriptions below of certain processes.

Manager module 121 may also be configured to communicate with a web client computer 135, either through network 110 or through a local area network (LAN) 140 included within data center 130. Network 140 may also provide a mechanism for communications between other components of data center 130, e.g., proxy module 116 and activity data store 125.

Proxy module 116 is generally configured to communicate, e.g., via network 110, with a remote customer application 145, e.g., through an application programming interface (API) 146 included in, or that operates in conjunction with, remote customer application 145. Application 145 and API 146 may be located on an application server 150 within a data center 165. Application server 150 may communicate with an entity data store 155, e.g., through a local area network 160 located within data center 165.

Mobile device 105 may be any GPS-capable mobile device that is also capable of installing, storing, and executing mobile application 106 as described herein. For example, mobile device 105 may be a BlackBerry® 8800 sold by Research In Motion Limited of Waterloo, Ontario, Canada, or an HP iPAQ hw6920 or hw6940 Mobile Messenger series device sold by Hewlett-Packard Company of Palo Alto, Calif.

As mentioned above, mobile application 106 may include a GPS module 107 and a GUI module 108. GPS module 107 generally includes instructions for obtaining geo-coordinates for mobile device 105 using known GPS technology, and for providing such GPS coordinates to manager module 121. GUI module 108 generally includes instructions for providing a GUI to user 101 on a display of mobile device 105. User 101 may thereby request and receive information, e.g., information from entity data store 155, from any location from which network 110 may be accessed. Advantageously, GPS module 107 may be automatically instantiated when mobile device 105 is powered on, and may continue to execute even after user 101 has taken action, e.g., selecting an “off” button or the like, to power off mobile device 105. Accordingly, GPS module 107 may provide information concerning a location or locations of user 101 and mobile device 105 in a manner that does not require attention from user 101.

Network 110 is generally a packet switched network, e.g., an internet protocol (IP) network. As such, network 110 generally uses one or more known protocols for transporting data, such as user datagram protocol (UDP), transport control protocol (TCP), hypertext transfer protocol (HTTP), etc. Further, network 110 may include a variety of networks such as a wide area network (WAN), e.g., the Internet, a local area network (LAN), etc. As is known, packet switched network 110 may be used to transport a variety of data, including multimedia data such as audio data and video data. Networks 140 and 160 are similarly packet switched networks, although networks 140 and 160 are generally not wide area networks and are generally not included within a wide-area network such as the Internet.

Application proxy server 115 and management server 120 are generally separate computer devices, although some or all of proxy module 116, manager module 121, and generation module 123 could be included together within a single computing device, possibly along with data store 125. However, as illustrated in FIG. 1, data store 125 may be located within a separate database server. Further, two or more of modules 116, 121, and 123 could be included together as a set of computer-executable instructions on a computer-readable medium.

Proxy module 116 and manager module 121 may send and receive messages according to known procedures and protocols, e.g., messages according to extensible markup language (XML) and simple object access protocol (SOAP). Similarly, mobile application 106 and API 146 may be configured to send messages according to procedures and protocols such as XML and SOAP. Accordingly, proxy module 116, manager module 121, mobile application 106, API 146, etc. may include web services, which are known to provide a mechanism for communications between various applications over a network.

Application 145 may be a known customer relationship management (CRM) application, including an API 146. For example, application 145 may be provided by salesforce.com, Inc. of San Francisco, Calif. or Microsoft Corporation of Redmond Wash., which provides Microsoft CRM. As is known, such applications generally include an API such as API 146 to receive messages from and send messages to remote applications such as proxy module 116. Further, a database such as entity data store 155 is known for storing customer information accessible by a CRM application, e.g., application 145.

Computing devices such as application proxy 115, management server 120, application server 150, and/or mobile device 105 may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices generally each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Databases or data stores described herein may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and is accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures.

### Activity Data Store

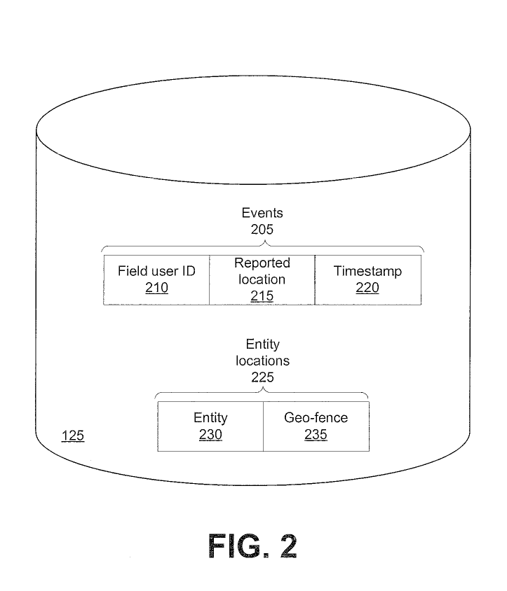

FIG. 2 illustrates exemplary elements of activity data store 125, including a set of events 205 and a set of entity locations 225. An event 205 includes a field user identifier 210, a reported location 215, and a timestamp 220. An entity location 225 includes an identifier for an entity 230 and a geo-fence 235.

An event 205 generally identifies the presence of a field user 101 at a particular place at a particular time. Field user identifier 210 is uniquely, or substantially uniquely, associated with a mobile device 105, and is generally taken to be thereby associated with a particular user 101 of mobile device 105. Reported location 215 is generally a set of geo-coordinates, e.g., a latitude and longitude, provided to manager module 121 by mobile device 105. Timestamp 220 is generally an identifier for a date and time in any one of a number of known formats, e.g., MM/DD/YY HOURS:MINS:SECS.

An entity location 225 generally identifies the location of an entity such as a customer, the term “customer” as used herein also referring to potential customers, business associates, business affiliates, business partners, suppliers, vendors, etc. Accordingly, entity 230 may uniquely or substantially uniquely identify a customer. Geo-fence 235 is generally a geo-coordinate, e.g., a latitude and longitude, and generally also a radius around the geo-coordinate, e.g., a distance in feet, yards, miles, etc. As described herein below, it may be determined whether a reported location 215 is within a geo-fence 235 by determining whether the reported location 215 is within a the predetermined radius of geo-fence 235.

It is to be understood that activity data store 125 may include numerous data elements not illustrated in FIG. 2. For example, data elements such as a street address for an entity 230, driving directions to an entity 230, contact information for an entity 230, etc. are not illustrated with reference to entity locations 225, but may be included in entity locations 225 or in some other set of data within activity data store 125. However, in general use of proxy module 116 to communicate with application 145 as described further below advantageously alleviates the need to store various customer data in activity data store 125, and further advantageously allows for access to entity data store 155, thereby minimizing the need to duplicate storage of data, synchronize databases, etc.

### Exemplary GUI

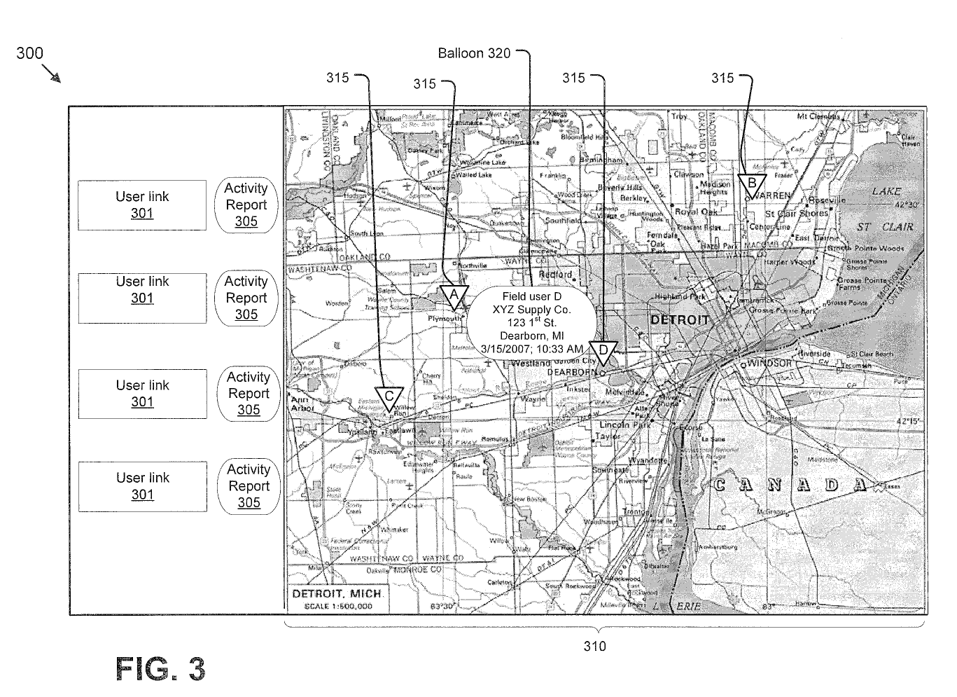

FIG. 3 illustrates an exemplary graphical user interface (GUI) 300 provided by manager module 121, e.g., to web client 135, thereby providing information to a user 136 of client 135. GUI 300 includes a set of user links 301, with an activity report button 305 associated with each user link 301. A map display 310 includes one or more user location icons 315 and a location description balloon 320.

Each user link 301 is generally associated with a particular field user 101. User link 301 is generally provided according to some known format such as hypertext markup language (HTML) or the like, and therefore may be associated with a uniform resource locator (URL) or the like. For example, selection of user link 301 may cause manager module 121 to display detailed information concerning a user 101, e.g., full name, job title, job responsibilities, contact information, work hours, etc. Selection of activity report button 305 may cause manager module 121 to display a report concerning activities of the associated user 101. For example, such a report may identify customer locations visited by the associated user 101 on each day for a week, including arrival times and departure times at each customer location. Of course, it is possible to omit activity report button 305, and it is further possible that selection of a user link 301 will cause manager module 121 to display a report concerning the associated user 101. Further, numerous other reports are possible, and moreover, GUI 300 may include elements in lieu of or in addition to button 305 to provide for selection of a report or information to be included on a report.

A number of known mapping applications may be used to provide map display 310 of a predetermined geographic area. As is known, a geographic area for display in a map, along with a level of detail for such a display, may be selected by a user 136, e.g., of web client 135.

User location icons 315 are superimposed on map display 310 to indicate present or last reported locations 215 of one or more users 101. Generally each location icon 315 corresponds to a user 101 indicated in one of the user links 301. Location description balloon 320 is generally displayed with respect to a location icon 315 selected by a user 136, e.g., of web client 135. Location description balloon generally includes information sufficient to identify a user 101 at a reported location 215, along with information about the reported location 215, e.g., a company name, address, a timestamp 220, etc.

### Exemplary Process Flows

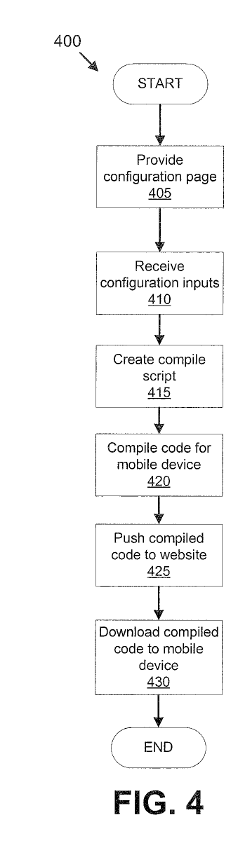

FIG. 4 illustrates an exemplary process 400 for providing a mobile application 106 to a mobile device 105.

In step 405, management server 120 provides to web client 135 a web page or pages or the like through which a user 136 of web client 135 may provide parameters for configuring a mobile application 106 to be installed on a mobile device 105. Such web pages may include any one or more of a number of mechanisms for receiving user input, such as HTML form elements and the like. Generally the webpage or pages provided in step 405 will be accessed by an administrative user within an organization responsible for the configuration of mobile applications 106 and mobile devices 105, rather than by a field user 101. Accordingly, such webpage or pages may be restricted according to a username and password or other authentication for such an administrative user.

A variety of different parameters within mobile application 106 may be configurable. For example, one configurable parameter generally included within mobile application 106 is a condition according to which mobile application 106 provides a reported location 215 to manager module 121. Such condition is generally simply the passage of a predetermined interval of time, e.g., thirty seconds, ten minutes, etc. however, other conditions triggering mobile application 106 to provide a reported location 215 to manager module 121 are possible, e.g., movement of a predetermined distance, e.g., one mile, from the previously reported location 215.

Another configurable parameter that may be included within mobile application 106 may be a frequency with which mobile application 106 requests information or instructions from manager module 121. Another configurable parameter may be whether mobile application 106 requests information or instructions from manager module 121 at all. For example, mobile application 106 may be configured to request information from manager module 121 concerning whether data store 125 includes any entities 230 having a geo-fence 235 including a present reported location 215. Further, mobile application 106 may be configured to request automatically upon identification of entities 230 within a geo-fence 235 further information about any such entities 230, e.g., contact information and/or background information concerning relevant personnel at such entities 230, records of previous contacts with such entities 230, etc.

A further configurable parameter that may be included within mobile application 106 may be a set of days and/or times for the operation of mobile application 106. For example, a field user 101 may power on and use a mobile device 105 seven days a week, but maybe it expected to visit customers only for particular days each week. Further, on days when a field user 101 is expected to visit customers, the field user 101 may be expected to do so only during predefined working hours, e.g., from 9 a.m. to 5 p.m. accordingly. The configuration webpage provided by management server 120, as mentioned above, may allow a user 136 of web client 135 to specify days and/or times for the operation of mobile application 106.

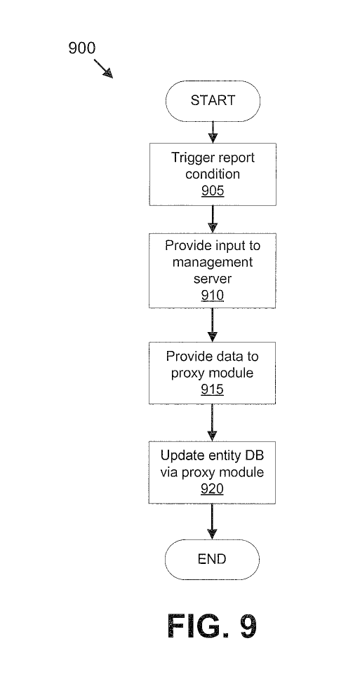

Yet another set of configurable parameters that may be included within mobile application 106 may be used to govern a form for gathering information from field user 101 to document a visit to a customer location. CRM applications generally rely on reports from field representatives to document the history of an organization's contacts with a customer. For example, mobile application 106 may be configured with parameters such that mobile application 106 will prompt a user 101 leaving a geo-fence 235 associated with an entity 230 for information such as the identity of persons at the customer entity 230 with whom the field user 101 met, contact information for such persons, any follow-up activities and/or deadlines associated with the customer entity 230, etc. As discussed further below, particularly with reference to FIG. 9, such information may advantageously be reported from mobile device 105 to customer application 145. Such use of mobile application 106 advantageously allows a field user 101 to report information to application 145 without having to complete a paper form, return to a central office, etc.

It is also possible to include within mobile application 106 configurable parameters related to mobile device 105, such as instructions to provide notifications to manager module 121 concerning a state of the mobile device 105, e.g., battery power is low, available amounts of memory or storage are low, etc.

As described with respect to process 400, configurable parameters may be compiled into program code for mobile application 106. However, other mechanisms for including configurable parameters in mobile application 106, or for updating configurable parameters within mobile application 106, may also be used. For example, in one embodiment, configurable parameters are included in an XML stream that is provided to mobile device 105, and used to update configurable parameters used by mobile application 106. In this embodiment, mobile application 106 is compiled with a set of default parameters, which are used in the event that no updated parameters have been provided. However, if updated parameters, e.g., in an XML stream, have been provided, such updated parameters are used in lieu of parameters compiled into code for mobile application 106. Accordingly, an organization may wish to provide a set of default parameters for all users 101 within the organization, but then override those parameters or provide different parameters for different sets of users 101, e.g., field technicians may require certain parameters to be different than parameters for sales representatives.

Returning now to the description of FIG. 4, following step 405, in step 410, a web server included in management server 120 receives configuration inputs provided by a user 136 of web client 135 as described above with respect to step 405. Such configuration inputs are provided to generation module 123.

Next, in step 415, generation module 123 creates a script according to which compilation of code for mobile application 106 will be performed. Such code may be compiled, for example, within the known BlackBerry® Java™ Development Environment (JDE) available from Research In Motion Limited of Waterloo, Ontario, Canada.

Next, in step 420, generation module 123 causes the script created in step 415 to be executed. Accordingly, a compiler program, such as one included in a JDE such as the Blackberry Java JDE mentioned above, compiles program code for mobile application 106.

Next, in step 425, generation module 123 provides compiled program code for mobile application 106 to a web server and/or to some other mechanism that can provide compiled mobile application 106 to mobile devices 105, e.g., an e-mail system utilizing an e-mail address delivering information to device 105 address.

Next, in step 430, one or more mobile devices 105 download and install mobile application 106. For example, a mobile device 105 may connect to a web client 135 through a Universal Serial Bus (USB) connection, where web client 135 then communicates with management server 120 to download and install mobile application 106 on the mobile device 105. A mobile device 105 may also include a wireless connection to network 110, e.g., through IEEE 802.11 or Bluetooth, allowing mobile device 105 to connect to management server 120 and to download mobile application 106.

Following step 430, process 400 ends.

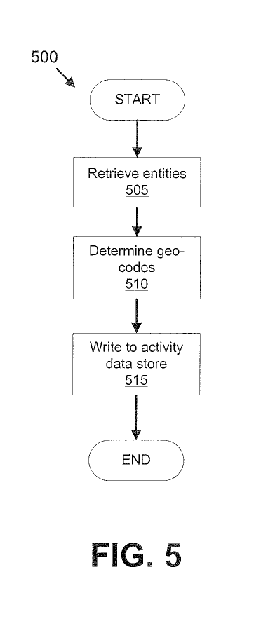

FIG. 5 illustrates an exemplary process for populating a set of entity locations 225 in activity data store 125.

In step 505, activity data store 125 retrieves a set of entities 230 from entity data store 155. As mentioned above, activity data store 125 generally includes a known relational database management system such as Oracle, SQL Server, etc. Accordingly, activity data store 125 may include a stored procedure or the like to communicate with proxy module 116 to request the retrieval of information concerning entities 230. As mentioned above, proxy module 116 may communicate with API 146 to retrieve information requested from entity data store 155 using known protocols, e.g., SOAP.

Next, in step 510, activity data store 125 determines geo-codes, i.e., latitudes and longitudes, associated with the entities 230 retrieved in step 505. Such determinations may simply be a matter of determining geo-codes, e.g., using geo-fences 235, retrieved from entity data store 155 along with entities 230. However, activity data store 125 may include program instructions for making such determination, e.g., for identifying a latitude and longitude associated with a street address in a known manner.

Next, in step 515, activity data store 125 writes entities 230 and associated geo-codes as geo-fences 235 to activity data store 125, e.g., as a table of entity locations 225. It is to be understood that geo-fences 235 may simply include a latitude, longitude data pair, or may also include a number specifying a radius, e.g., in feet, yards, miles, etc. for determining a geo-fence associated with the specified latitude and longitude. That is, a radius for a geo-fence 235 may be included within the geo-fence 235 or may be supplied externally, e.g., by manager module 121 as discussed further below.

Following step 515, process 500 ends.

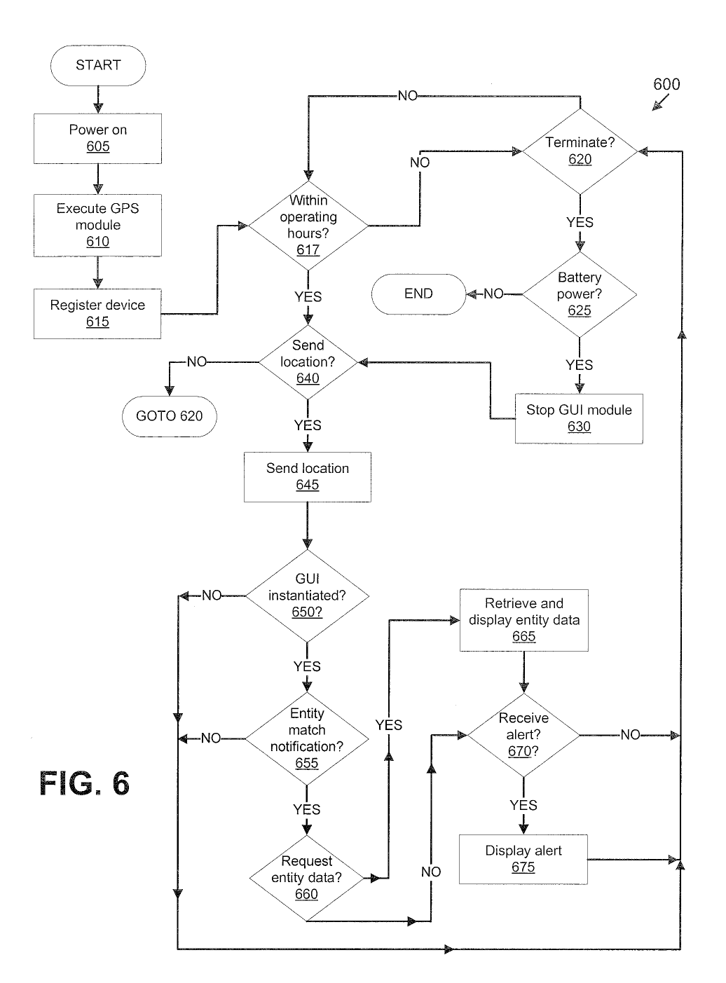

FIG. 6 illustrates an exemplary process 600 for use of a mobile device 105.

In step 605, mobile device 105 is powered on.

Next, in step 610, GPS module 107 is instantiated. Generally, GPS module 107 of mobile application 106 automatically begins execution when mobile device 105 is powered on, e.g., immediately following step 605. GUI module 108 is generally instantiated manually by a user 101, as discussed below, although GUI module 108 could also automatically begin execution when mobile device 105 is powered on. Further, embodiments are possible in which a user 101 manually instantiates GPS module 107 when mobile device 105 is powered on. However, inasmuch as one purpose of mobile application 106 is to track activities and movements of user 101, it is generally desirable and advantageous for GPS module 107 to execute automatically and without intervention or even conscious attention from a user 101.

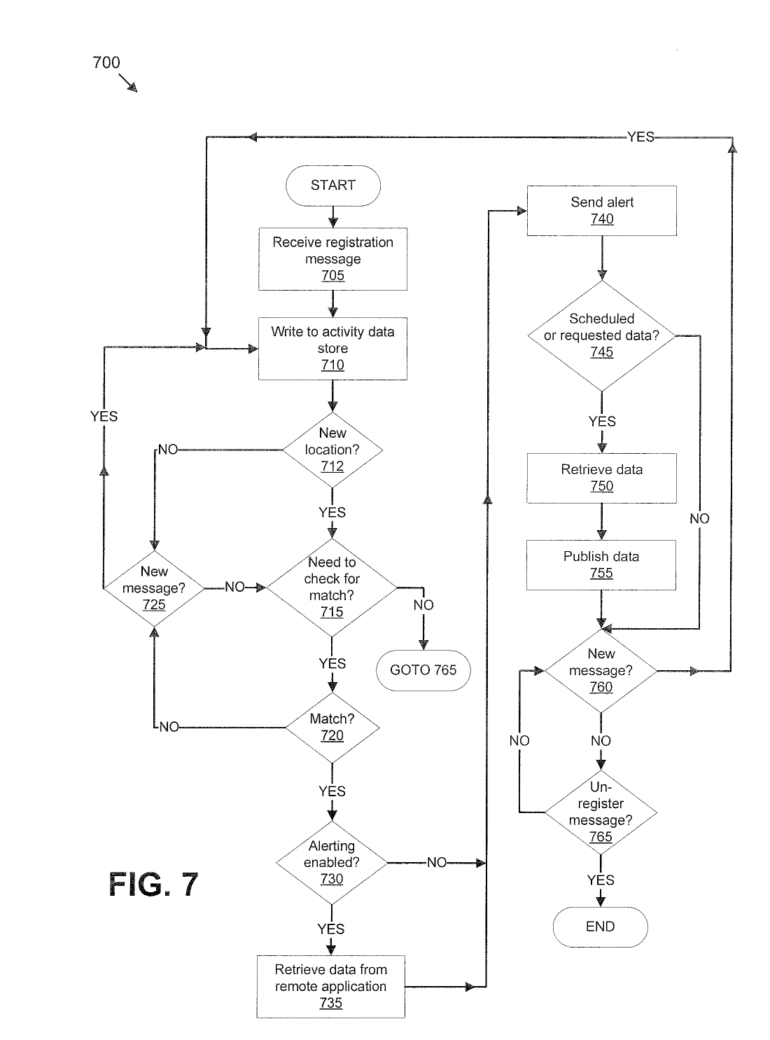

Next, in step 615, mobile application 106 sends a message, e.g., according to SOAP, to register mobile device 105 with manager module 121 as an active mobile device 105. Accordingly, manager module 121 may be programmed to expect to receive messages, e.g., including reported locations 215, from mobile device 105 at predetermined intervals. Further, such registration information may include a current network address at which manager module 121 may direct messages for the mobile device 105. Registration of mobile device 105 with manager module 121 is described in more detail with respect to FIG. 7 below.

Next, in step 617, mobile application 106 determines whether a current time, e.g., as determined by a clock within mobile device 105, is within a predefined set of operating hours for mobile application 106. As mentioned above, a predefined set of operating hours for mobile application 106 may be provided as a configurable parameter by an administrator, e.g., a user 136 of web client 135. If the current time is not within the predefined set of operating hours for mobile application 106, step 620 is executed next. However, if the current time is within the predefined set of operating hours then step 640 is executed next.

In step 620, mobile application 106 determines whether a request has been received to terminate mobile application 106. Generally a user 101 of mobile device 105 will be provided with a mechanism for terminating GUI module 108, but not GPS module 107. Accordingly, a user 101 may provide input terminating GUI module 101. Alternatively or additionally, an operating system of mobile device 105 may provide to mobile application 106 an indication that the mobile device 105 is being powered off, in which case GUI module 108 may be terminated. However, GPS module 107, once it has begun execution, generally continues execution even after a user 101 has provided input to power off mobile device 105. That is, when an operating system in mobile device 105 provides a “power off” event or the like, mobile application 106 captures the event and maintains operations of mobile device 105 sufficient to support GPS module 107, e.g., GPS operations, radio operations for communicating with management server 120 through network 110, etc. In any event, if a request has been received to terminate mobile application 106, step 625 is executed next. Otherwise, process 600 returns to step 617.

In step 625, if battery power (or other electrical power) to mobile device 105 has been terminated, then mobile application 106, including GPS module 107 and GUI module 108, is terminated, following which, process 600 ends. However, if battery power (or other electrical power) is still present in mobile device 105, then step 630 is executed next.

In step 630, GUI module 108 is stopped. Step 640 is executed following step 630.

In step 640, which may follow step 630 or step 617, mobile application 106 determines, generally according to a predetermined condition such as passage of a predetermined interval of time as described above, whether to send a reported location 215 to manager module 121. If such determination is positive, process 600 proceeds to step 645. Otherwise, process 600 returns to step 620.

Next, in step 645, mobile application 106, e.g., GPS module 107, sends a reported location 215, generally along with a field user ID 210 and a timestamp 220, to manager module 121. Timestamp 220 may be retrieved from a clock included within mobile device 105, from a clock included within activity data store 125, or from some other device, like a centralized time server. Field user ID 210 may be obtained and stored in mobile device 105 in a variety of ways, e.g., according to input required from user 101 upon powering on mobile device 101, upon installing mobile application 106, or as a custom parameter included mobile application 106 when mobile application 106 is compiled. Alternatively, field user ID 210 may be associated in activity data store 125 with an identifier for mobile device 105, e.g., an electronic serial number (ESN) or network media access control (MAC) address, etc. Such identifier for mobile device 105 may then be used to retrieve an appropriate field user ID 210 to store in an event 205 along with a reported location 215 and a timestamp 220.

Next, in step 650, mobile application 106 determines whether GUI module 108 has been instantiated. That is, a user 101 may generally provide at a time of the user's choosing, input, e.g., selecting a menu item, icon, or the like to instantiate GUI module 108. In general, GUI module 108 allows a user 101 to request and receive information concerning an entity 230, including information from entity data store 155. If GUT module 108 has not been instantiated, process 600 returns to step 620. Otherwise, step 655 is executed next.

In step 655, mobile application 106 determines whether it has received a notification from manager module 121 that the reported location 215 provided as described with reference to step 645 has been matched to an entity 230 in activity data store 125. A determination of whether such a match exists is described in more detail below with respect to FIG. 7. If mobile application 106 does receive such notification, such entity 230 may be identified on a display of mobile device 105 and/or a user 101 may be presented with various options for receiving additional information concerning the entity 230, e.g., options to request one or more of contact information for relevant personnel associated with the entity 230, information about prior history with the entity 230, etc., and step 660 is executed next. Otherwise, process 600 returns to step 620.

In step 660, mobile application 106 determines whether a user 101 has provided input, e.g., via an interface provided by GUI module 108, requesting information concerning the entity 230 identified as described above with respect to step 625. GUI module 108 may provide for user 101 to request a variety of information concerning an entity 230, e.g., names and titles of relevant personnel within the entity 230, contact information, records of previous visits, pending orders, etc. If user 101 has made no such request, then step 670 is executed next. However, if such a request has been made, then step 665 is executed next.

In step 665, mobile application 106 requests and receives from manager module 121 information concerning the entity 230 identified as described above with respect to step 625, according to user 101 input received as described above with respect to step 635. Steps performed by manager module 121 to provide such information are described below in more detail with respect to FIG. 7. The information provided in step 665 may be displayed in a graphical user interface or the like included in mobile device 105.

In step 670, which may follow either step 660 or step 665, mobile application 106 determines whether manager module 121 has provided an alert concerning the entity 230 identified as described above with respect to step 645. As discussed below in more detail with respect to FIG. 7, activity data store 125 and/or manager module 121 may be programmed to provide alerts concerning an entity 230 proximate to a field user 101. Such alerts may include the variety of information concerning an entity 230 mentioned above, e.g., names and titles of relevant personnel within the entity 230, contact information, records of previous visits, pending orders, etc. In any event, if an alert is received in step 670, step 675 is executed next. Otherwise, process 600 returns to step 620.

In some embodiments, step 670 may be executed even if it was determined in step 650 that GUI module 108 is not instantiated. In these embodiments, mobile application 106 may inform user 101, e.g., by displaying a message in a display of mobile device 105, that's an alert has been received. Mobile application 106 may further prompt the user 101 to instantiate or log in to GUI module 108 to view the received alert.

In step 675, mobile application 106 causes the alert received in step 645 to be displayed, e.g., in a graphical user interface included in mobile device 105.

Process 600 ends following step 675.

FIG. 7 illustrates an exemplary process 700 for management server 120 to communicate with a mobile device 105.

In step 705, manager module 121 receives a registration message, e.g., a message according to SOAP, from a mobile application 106 in a mobile device 105. Such a registration message generally includes a unique or substantially unique identifier for a field user 101 associated with the mobile device 105 and/or a unique or substantially unique identifier for the mobile device 105, as discussed above.

Generally upon receiving a registration message, manager module 121 performs an authentication procedure for mobile device 105 with respect to application 145. That is, through a proxy module 116, a request for authentication is made through API 146, e.g., providing a login name and password for user 101, a unique identifier for mobile device 105, etc. In one embodiment, application 145 returns a globally unique identifier (GUID) that may then be stored in memory of mobile device 105 and used by mobile application 106 for further communications with application 145, e.g., through manager module 121 and proxy module 116.

Next, in step 710, manager module 121 sends a message to activity data store 125 concerning the registration message received as described above with respect to step 705. Upon receipt of such message, activity data store 125 generally executes a stored procedure or the like to create and store an event 205 including a field user ID 210, a reported location 215, and a timestamp 220, all of which will generally be included in the registration message received as described above with respect to step 705.

Next, in step 712, manager module 121 determines whether the reported location 215 recorded as described above with respect to step 710 has previously been included in an event 205 associated with the field user ID 210 included in the message received in step 705. Such a determination is generally limited to whether reported location 215 has been recorded since the registration of the mobile device 105 in step 705. If the recorded reported location 215 is a “new location,” then step 715 is executed next. Otherwise, step 725 is executed next.

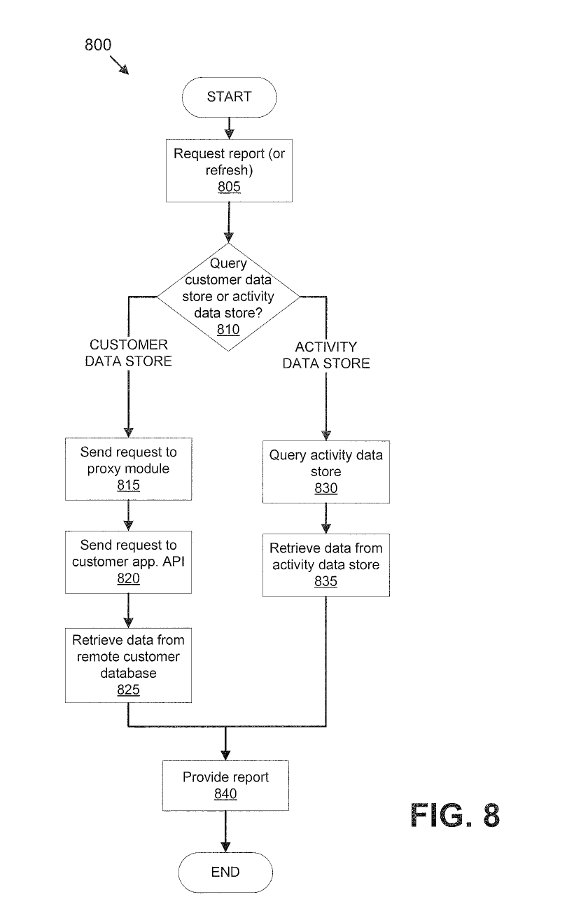

In step 715, manager module 121 determines whether to request activity data store 125 to determine whether a reported location 215 can be matched with an entity 230, that is, whether the reported location 215 is associated with, i.e., is within a geo-fence 235 associated with, an entity 230. This determination may include determining whether manager module 121 has received a request for a report, e.g., from a web client 135 as described with respect to FIG. 8 below, or whether mobile application 106 is configured to be able to request information and/or receive alerts concerning entities 230. If any of these determinations are positive, step 720 is executed next. Otherwise, step 765 is executed next.

In step 720, manager module 121 queries activity data store 125 to determine whether a reported location 215 can be matched with an entity 230. If not, step 725 is executed next. Otherwise, step 730 is executed next.

In step 725, which may follow any of steps 712, 715, or 760, manager module 121 determines whether a new message indicating a reported location 215 has been received from the mobile device 105 registered as described above with respect to step 705. If not, step 765 is executed next. Otherwise, process 700 returns to step 710 to record the newly received reported location 215.

In step 730, which generally follow step 720, manager module 121 determines whether the mobile application 106 providing messages as described, e.g., with respect to steps 705 and 725, is configured to receive alerts concerning entities 230. Such determination may be made, for example, according to information included in a message received from mobile application 106. To take another example, data store 125 may include information associated with particular users 101 and/or mobile devices 105 indicating whether such users 101 and/or mobile devices 105 are configured to receive alerts. If the mobile application 106 is configured to receive alerts concerning entities 230, then step 735 is executed next. Otherwise, step 745 is executed next.

In step 735, manager module 121 queries data store 125 and/or proxy module 116 for information that may be provided in an alert to mobile application 106 concerning an entity 230 presently being visited by field user 101. As previously discussed, proxy module 116 may in turn send a message to application server 150 formatted for API 146. Such a message received by customer application 145 through API 146 may cause customer application 145 to query entity data store 155, thereby providing information through API 146 back to proxy module 116, which information proxy module 116 may in turn provide to manager module 121 to be included in an alert to mobile application 106 included in mobile device 105.

Next, in step 740, manager module 121 sends an alert message including information obtained as described above with respect to step 735 to mobile application 106.

In step 745, which may follow either step 730 or step 740, manager module 121 determines whether either a user 101 of mobile application 106 or a user 136 of web client 135 has requested a report concerning entity 730. It is to be understood that a request for a report from web client 135 may be made on a scheduled basis, e.g., according to an automatic refresh of GUI 300 performed in a known manner according to instructions included in a script, e.g., JavaScript or the like, used as part of providing GUI 300. If a report request has been received, step 750 is executed next. Otherwise, step 760 is executed next.

In step 750, manager module 121 retrieves requested data much as described above with respect to step 735.

Next, in step 755, manager module 121 publishes the data retrieved as described above with respect to step 750. Such publication may include providing requested information, e.g., names of personnel, contact information, recorded visit history, etc. to mobile application 106. Further, such publication may include providing a report to web client 135, e.g., as described above with respect to FIG. 3.

In step 760, much as in step 725 described above, manager module 121 determines whether a new message indicating a reported location 215 has been received from the mobile device 105 registered as described above with respect to step 705. If so, process 700 returns to step 710. Otherwise, step 765 is executed next.

In step 765, manager module 121 determines whether an un-registration message has been received from mobile application 106. That is, as described above with respect to FIG. 6, when mobile device 105 is powered off, or time passes to become outside a predetermined set of hours of operations, etc., mobile application 106 may provide an un-registration message to manager module 121. If an un-registration message is received, then process 700 ends. Otherwise, process 700 returns to step 760.

FIG. 8 illustrates an exemplary process 800 for providing reports and/or alerts to mobile application 106 and/or web client 135.

In step 805, manager module 121 receives a request for a report from a mobile application 106 or a web client 135, or possibly a request to determine whether alert data exists and if so to provide such alert data to a mobile application 106. A request for a report may be provided to manager module 121 directly from a web client 135, possibly in conjunction with a web server application operating on management server 120. Further, a request for a report or to determine alert data may be provided to manager module 121 from manager module 121, which, as described above, selectively communicates with mobile application 106 within mobile device 105. In addition, a request for a report may be a request to refresh a report as described above.

Next, in step 810, manager module 121 determines whether the requested data may be found in activity data store 125 or entity data store 155. If it is necessary to query entity data store 155, e.g., a database containing data concerning customers, then step 815 is executed next. If it is necessary to query activity data store 125, then step 830 is executed next. Note that it is possible that data for a report may require queries to both activity data store 125 and entity data store 155, in which case steps 815-825 and steps 830-835 may be executed in parallel.

In step 815, manager module 121 sends a query for entity data store 155 to proxy module 116.

Next, in step 820, proxy module 116 in turn sends a message, e.g., according to SOAP, to API 146 to obtain data for the report requested in step 805.

Next, in step 825, in response to the query of step 820, application 145 retrieves the requested data from data store 155 and returns to proxy module 116 a message including the requested data, if the requested data is found, or otherwise indicating the requested data cannot be found. Proxy module 116 in turn returns the requested data to manager module 121. Step 840 is executed following step 825.

In step 830, manager module 121 sends a query to activity data store 125 to obtain data for the report requested in step 805.

Next, in step 835, in response to the query of step 830, activity data store 125 retrieves the requested data and returns it to manager module 121 or returns a message indicating that the requested data cannot be found. Step 840 is executed following step 835.

In step 840, manager module 121 assembles the data received in step 825 and/or step 835, and provides the requested report or alert to web client 135 or mobile application 106 as appropriate.

Following step 840, process 800 ends.

As was mentioned above, entity data store 155, e.g., such as might be included in a CRM system, may rely on information concerning contacts with an entity 230 to provide and maintain historical information concerning a customer relationship. FIG. 9 illustrates an exemplary process 900 for reporting information from a mobile device 105 to a remote entity data store 155.

In step 905, a condition is triggered for a field user 101 to provide information concerning a visit to an entity 230. As discussed above, such condition may be included in mobile application 106 as a configurable parameter, e.g., provided by a user 136 of web client 135. For example, the condition may include departure of a field user 101 from a geo-fence 235 including an entity 230, the passage of a predetermined period of time following such departure, etc.

Next, in step 910, field user 101 provides input to mobile device 105 as may be requested by a GUI generated by mobile application 106. Mobile device 105 then provides this input to management server 120, e.g., to manager module 121. For example, mobile application 106 may provide a form or the like through which user 101 may enter the name or names of persons visited at entity 230, descriptions of transactions conducted or business discussed, and he required follow-up activities and/or deadlines, future meetings to be placed on a calendar, etc. Further, mobile application 106 may be programmed to prevent user 101 from accessing other features available through mobile device 105 until such input is provided, or to provide user 101 with regular reminders that such input is required until it is provided, etc.

Next, in step 915, manager module 121 provides data received as described above in step 910 to proxy module 116, along with an instruction to provide such data to application 145 for entity data store 155.

Next, in step 920, proxy module 116 provides data received as described above in step 915 to application 145 through API 146, whereby application 145 stores the received data in entity data store 155.

Following step 920, process 900 ends. However, it should be understood that steps 910 through 920 of process 900 may be repeated as necessary to accommodate multiple input screens provided by mobile application 106 on mobile device 105. Further, it should be understood that data provided in step 910 to manager module 121 could also be stored in activity data store 125, and that entity data store 155 could be updated by a synchronization or the like with activity data store 125. Moreover, it may be desirable to store data provided in step 910 in activity data store 125 at least temporarily, perhaps also with an indicator associated with an event 205 and/or entity location 225 indicating that a particular field user 101 has provided data as described above with respect to step 910. Such data stored in activity data store 125, including the aforementioned indicator, may be used to provide reports to a user 136 of web client 135 as described above

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising:
a proxy module configured to communicate with a remote application via a network;
a manager module that is in selective communication with a remote device via the network, and that selectively receives, from the remote device, location information identifying a location of the remote device; and
a data store that includes a customer location and an event, the at least one customer location being associated with a customer, the manager module being configured to write the event to the data store upon receiving the information concerning the location of the remote device, the event including the location of the remote device and an identifier for the remote device or a user thereof;
the manager module being further configured to selectively query the data store for an association between the event and the customer location, and to provide the association to the proxy module, and
the proxy module being further configured to query the remote application via the network, upon receiving the association, for information regarding a customer associated with the customer location, and to provide responsive customer information to the manager module.

2. The system of claim 1, the manager module being further configured to provide at least some of the responsive customer information to at least one of a web client and the remote device.

3. The system of claim 1, wherein the event further includes a time.

4. The system of claim 1, further comprising a mobile application included on the remote device that is configured to cause the remote device to provide, according to a predetermined condition, the location information.

5. The system of claim 4, further comprising a generation module configured to accept one or more parameters and to use the one or more parameters to generate code for the mobile application.

6. The system of claim 4, wherein the predetermined condition is the passage of a predetermined period of time.

7. The system of claim 1, the manager module being further configured to receive customer visit data from the remote device and to provide the customer visit data to the proxy module, the proxy module being further configured to provide the customer visit data to the remote application.

8. A method, comprising:
receiving, from a remote device, location information identifying a location of the remote device; and
writing an event to a data store upon receiving the information concerning the location of the remote device, the event including the location of the remote device and an identifier for the remote device or a user thereof;
selectively querying the data store for an association between the event and the location; and
querying a remote application via a network, upon receiving the association, for information regarding a customer associated with the customer location.

9. The method of claim 8, further comprising receiving, from the remote application, responsive customer information.

10. The method of claim 9, further comprising providing at least some of the responsive customer information to at least one of a web client and the remote device.

11. The method of claim 8, wherein the event further includes a time.

12. The method of claim 8, further comprising causing the remote device to provide the location information according to a predetermined condition.

13. The method of claim 12, wherein the predetermined condition is the passage of a predetermined period of time.

14. The method of claim 8, further comprising:
receiving customer visit data from the remote device; and
providing the customer visit data to the remote application.

15. A computer-readable medium tangibly embodying a set of computer executable instructions, the instructions including instructions for:
receiving, from a remote device, location information identifying a location of the remote device; and
writing an event to a data store upon receiving the information concerning the location of the remote device, the event including the location of the remote device and an identifier for the remote device or a user thereof;
selectively querying the data store for an association between the event and the location; and
querying a remote application via a network, upon receiving the association, for information regarding a customer associated with the customer location.

16. The medium of claim 15, the instructions further comprising instructions for: receiving, from the remote application, responsive customer information.

17. The medium of claim 16, the instructions further comprising instructions for: providing at least some of the responsive customer information to at least one of a web client and the remote device.

18. The medium of claim 15, wherein the event further includes a time.

19. The medium of claim 15, the instructions further comprising instructions for: causing the remote device to provide the location information according to a predetermined condition.

20. The medium of claim 19, wherein the predetermined condition is the passage of a predetermined period of time.

21. The medium of claim 15, the instructions further comprising instructions for:
receiving customer visit data from the remote device; and
providing the customer visit data to the remote application.
